(19) United States
(12) Patent Application Publication
(10) Pub. No.: US 2007/0233647 A1
(43) Pub. Date: Oct. 4, 2007

(54) Sharing Items In An Operating System

(75) Inventors: Anshul Rawat, Kirkland, WA (US); Chris J. Guzak, Kirkland, WA (US); Edward B. Averett, Kirkland, WA (US); John E. Brezak, Woodinville, WA (US); Mohammed A. Samji, Bellevue, WA (US); Ramkumar Ramasubramanian, Bellevue, WA (US); Robert P. Sweeney, Bothell, WA (US)

Correspondence Address: BANNER & WITCOFF, LTD.;ATTORNEYS FOR CLIENT NOS. 003797 & 013797, 1100 13th STREET, N.W., SUITE 1200, WASHINGTON, DC, 20005-4051, US

(73) Assignee: Microsoft Corporation, Redmond, WA (US)

(21) Appl. No.: 11/278,000

(22) Filed: Mar. 30, 2006

(51) Int. Cl. G06F 17/30

(52) U.S. Cl. 707/3

(57) ABSTRACT

Systems and methods are provided for sharing items and viewing shared items in an operating system. A user may initiate a search that executes a query on the file system, returning a list of items owned by the user and shared out to other users. In order to increase efficiency and usability of such a query, an index may be created based on the owner and user permissions of the items in the file system. A user interface integrated into the operating system may display the shared items in a single flat list, or search folder, regardless of the various physical locations of the items on the system.

### BACKGROUND

The sharing of items on a computer is a common source of confusion for users. In many systems, users are limited to just sharing out entire folders, and do not have the ability to share out individual files or items. In order to share files in such systems, a user typically has to create a folder, organize the desired files in the folder, and then share the folder. File sharing has further been complicated by the fact that users also may want to share files in different locations, such as on different devices, on other PCs, or online. A user may also find it difficult to recall where and how they stored certain files.

Organizing and sharing files is also complicated by the fact that name spaces may vary across computers, which may be another source of user confusion. For example, certain operating systems may require short share names with no spaces in order to be correctly displayed to other users. Additionally, software applications on the computer also often save user-owned files to their own directory or other name spaces, which can make it difficult for users to find their way back to the files. Applications often have default directories and places they save documents. A user often has to search through their hard disk and make guesses about where a shared file or a file to be shared is stored. This problem becomes more common with the developments of digital media services that have multiple content types (e.g., pictures, music, video). Sharing files across computer systems is further complicated by the extra step of requiring a user to open a firewall and create a server message block (SMB) share before a folder can be shared over a network.

More recent systems allow individual files and other non-file items to be shared out, in addition to supporting typical folder sharing. Additionally, more complex sharing mechanisms are now possible, such as sharing the results of searches or queries in search folders, e.g., folders presenting query results from multiple physical locations of one or more file systems. However, the ability to share individual files and other items present additional difficulties for users. The new ways to share items make it more difficult for users to know what files have been shared out and to whom. In fact, to identify every shared file, folder, or item on the system, a user may need to navigate through every folder in the file system hierarchy and individually examine the security or sharing properties associated with every folder, file, or item. Even once a single item is identified, viewing or setting permissions on the item is often ambiguous. For example, a user may set one level of permissions on a file, then subsequently set a different level of permissions on the file's parent folder. These multiple sets of permissions may confuse a user trying to view or update the user permissions associated with the file.

### SUMMARY

In light of the foregoing background, the present disclosure is directed to a system and method for sharing items in an operating system that overcome the foregoing and other disadvantages. The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

According to one aspect of the present disclosure, a user may initiate a search that executes a query on the file system, returning a list of items owned by the user and shared out to other users on the system. A user interface integrated into an operating system may display the shared items in a single flat list, or search folder, regardless of the various physical locations of the items on the system. The user interface may further support adding to or updating the user permissions on the displayed items, or on other items returned by other searches.

According to another aspect of the present disclosure, an index may be created in an operating system, or a user permission property may be added to an existing index, in order to increase the efficiency and usability of such a query. The file owner and user permission properties of the index may enable faster and more robust searches based on whether or not an item has been shared out and to whom it has been shared. Thus, for example, sets of commonly owned or commonly permissioned items may be returned from a query without requiring an entire volume scan, or requiring a user to individually navigate through the file system hierarchy.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating an operating environment in which one or more illustrative aspects may be performed;

FIG. 2 is a flowchart showing illustrative steps for maintaining an index with user permission information for files in an operating system, in accordance with one or more illustrative aspects of the present disclosure;

FIG. 3 is a flowchart showing illustrative steps for querying an index with user permission information and displaying results to a user, in accordance with one or more illustrative aspects of the present disclosure; and

FIGS. 4-9 are screenshots of a user interface relating to sharing files and viewing shared files in an operating system, in accordance with one or more illustrative aspects of the present disclosure.

### DETAILED DESCRIPTION OF ILLUSTRATIVE EMBODIMENTS

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention

Illustrative Operating Environment

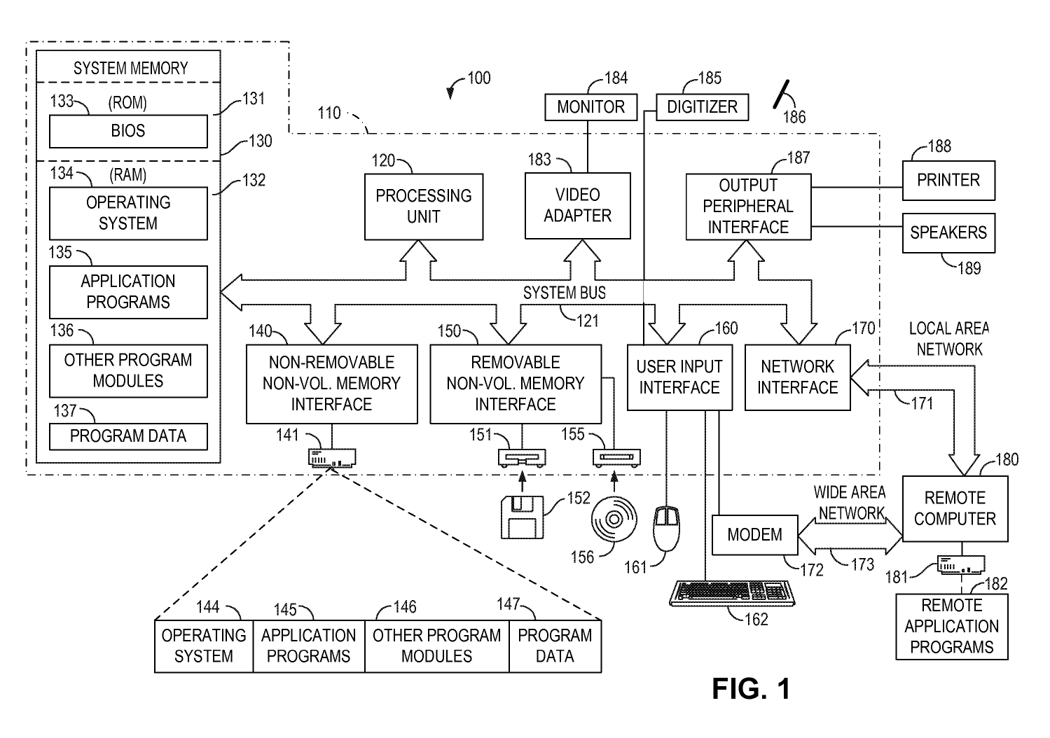

FIG. 1 illustrates an example of a suitable computing environment 100 in which the invention may be implemented. The computing environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers; server computers; portable and hand-held devices such as personal digital assistants (PDAs), tablet PCs or laptop PCs; multiprocessor systems; microprocessor-based systems; set top boxes; programmable consumer electronics; network PCs; minicomputers; mainframe computers; game consoles; distributed computing environments that include any of the above systems or devices; and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an illustrative system for implementing the invention includes a general purpose computing device in the form of a computer 110. Components of computer 110 may include, but are not limited to, a processing unit 120, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, DVD or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, DVD, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port, universal serial bus (USB), or IEEE 1394 serial bus (FireWire). At least one monitor 184 or other type of display device may also be connected to the system bus 121 via an interface, such as a video adapter 183. The video adapter 183 may support advanced 3D graphics capabilities, in addition to having its own specialized processor and memory. Computer 110 may also include a digitizer 185 to allow a user to provide input using a stylus or other pen input device 186. In addition to the monitor, computers may also include other peripheral output devices such as speakers 189 and printer 188, which may be connected through an output peripheral interface 187.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 may be connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 182 as residing on memory device 181. It will be appreciated that the network connections shown are exemplary and other means of establishing a communications link between the computers may be used.

One or more aspects of the invention may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

Illustrative Embodiments

Illustrative embodiments described herein may aid a user to view and define shared items on a computer. Although the illustrative embodiments described in these examples often refer to sharing files, the present disclosure is not limited to such uses. Non-file items such as physical folders, non-physical folder (e.g., search folders), and resource links or shortcuts to items may also be shared in embodiments supported by the present disclosure. Additionally, other items or groups of item that are not typical files may also be sharable, for example, electronic communications (e.g., email, instant messages, etc), contact items or calendar items stored on the computer.

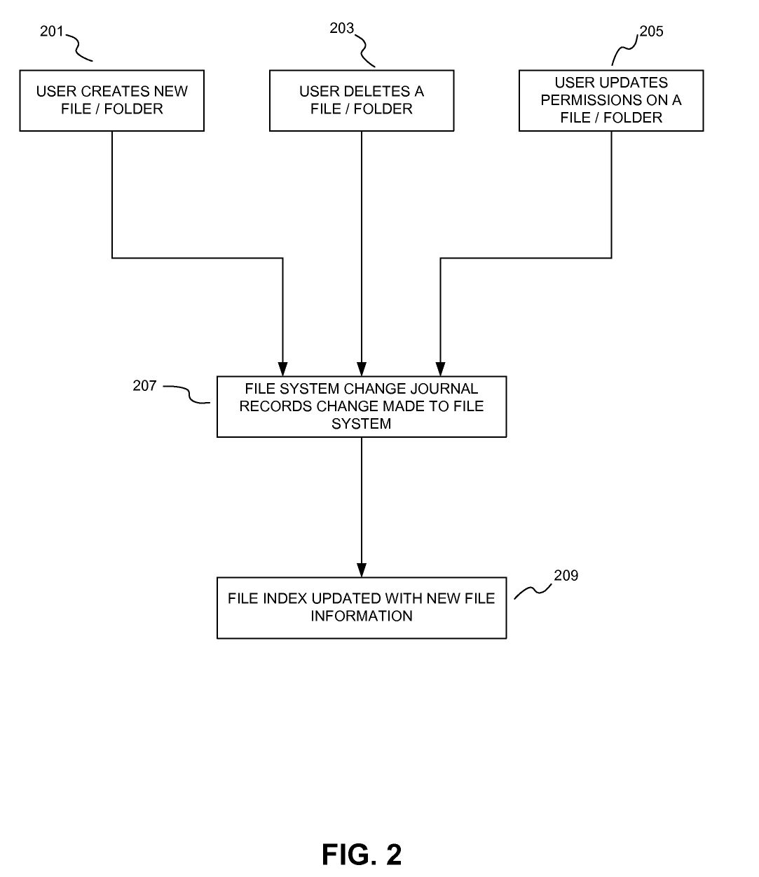

Referring to FIG. 2, a flowchart is shown with illustrative steps for maintaining an index with user permission information. At step 201, a user creates a new file or folder at some location in the physical file system of the computer. In some embodiments, file creation by a user may trigger an operating system action to record and/or respond to the new file. Examples of such operating system actions are described in detail below. Alternatively, in step 203, a user deletes an existing file or folder from the physical file system of the computer, which may similarly invoke a recording and/or responding action by the operating system. As another alternative, in step 205, a user updates the user permissions on an existing file or folder on the physical file system. Updating user permissions may similarly invoke a recording and/or responding action by the operating system.

In step 207, one of the user actions 201, 203, and 205, or some combination of multiple actions is recorded in an operating system event recorder. For example, in a Microsoft Windows® brand operating system with a New Technology File System (NTFS), the NTFS Change Journal may record an entry every time a file or directory is updated on the system. Thus, a software application or operating system thread may continuously or periodically monitor the NTFS Change Journal to recognize and respond to any change in user permissions on an item in the system. For example, the Indexing Service of Microsoft Windows® operating systems may track file changes in the NTFS Change Journal, including creation of new files or folders 201, deletion of existing files or folders 203, or changing of user permissions on files or folders 205. Other file systems may be used as well.

Step 209 relates to a file index that may be maintained by the operating system. A file index may refer to a data structure, such as a database table, hash table, or binary tree created by the operating system to store data relating to the files and folders on the system. File indexes may enable faster and more robust searching capabilities by organizing the data in the data structure according to certain properties of the items or item references stored in the index. Additionally, the content of individual files may be indexed to facilitate text searching across large portions of the file system. For example, the NTFS file system of a Microsoft Windows® brand operating system creates a file index including several common properties relating to the items stored on the system. For any property included in the index, the operating system updates the file index periodically to reflect any changes in this property made for any item in the file system. For example, if “file type” is an indexed property in the file index, and a new document file is created (e.g., a file with a “.doc” extension), then portions of the file index dedicated to storing the file type property may be updated to add information corresponding to the new file in at the appropriate location in the index (e.g., into the document section of the file type property storage area of the file index). Thereafter, when a user searches the computer for files of a specific file type (e.g., document files), the operating system can use the file index to quickly identify all files of the requested type, rather than potentially having to scan the entire volume or navigate through the entire file system hierarchy to determine the file type for every resource in the system.

Thus, in step 209, the file index is updated to reflect the change in the user permissions associated with the new and/or changed item. As described above, either the creation of a new file 201, deletion of an existing file 203, or modification of the user permissions of an existing file 205, may cause the operating system to perform automatic updates to the file index, and specifically to the user permission property of the file index. The system may also concurrently update the metadata properties of the individual files. If such updates are not performed by the operating system periodically or synchronously after a change to an item in the system, the data stored in the file index may become stale and the ability to perform quick and effective item searches on the file system based on user permissions or item ownership may be compromised.

In certain embodiments, the property written into the file index for recording user permissions data may take the form of either an access control list (ACL) or an identifier to an ACL. An ACL is a data structure that stores a set of user permissions associated with a file or folder. For example, an ACL may be a table containing entries that specify individual user or group rights to specific system objects, such as an executable program, folder, or file. The entries in the ACL table are often known as access control entries (ACE). The privileges or permissions defined in the ACL for an item may determine the specific access rights for that item, such as whether a user can read from, write to, or execute the object. In some implementations, an ACE may also control whether or not a user, or group of users, may alter the ACL for an item.

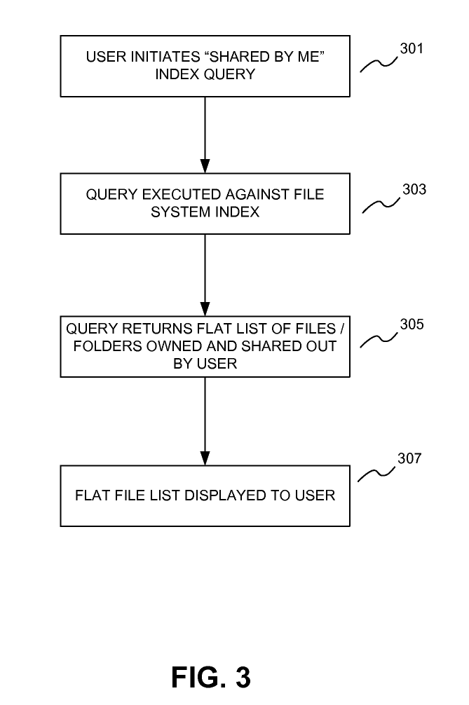

Referring to FIG. 3, a flowchart is shown with illustrative steps for querying a file index with user permission information, and returning the query results to a user. In step 301, the user may perform a file system search which initiates a query, for example, a “shared by me” search/query. In performing the search, the user requests to view all of the files on the computer that are owned by the user and that have been shared out by the user to one or more different users. A file has been shared out if the permissions or privileges to read from the file, write to the file, execute the file, etc., have been granted to a user other than the file owner. As stated above, a user may have shared out many different folders, files, and other items, which may reside in different physical locations in the file system. The shared by me query may be configured to return all of the user's shared out items on the computer, regardless of physical location (e.g., including network drives, logical drives, external storage devices, etc.). Alternatively, a different implementation of the shared by me query may support additional user-specific criteria. For example, the shared by query may be configured to only return shared files in a specified range of physical locations on the computer, or to only return shared files with specified file types, etc. Additionally, certain users with elevated privileges, such as computer administrators, may be able to issue a shared by me query for other users on the system.

In step 303, the shared by me query is executed on the file index. As described above, this step is optional. A file index with a user permissions property need not exist to successfully perform a shared by me query or similar file system search based on file ownership or user permissions. For example, without a user permission property in a file index, the file system volume may be scanned and each individual file may be examined to identify a set of items owned by the user and shared out to at least one other user. However, a user permission property in a file system index may greatly increase the efficiency of executing such a query, since scanning all the files in a file system may take a prohibitively long amount of time in computer systems with large numbers of files. Additionally, a file index with user permission properties stored may group all the items in the system shared out by a user together, thus enabling a complete result set to be identified with only a single search for the starting point of the group within the index structure. In contrast, without an indexed system, an entire file system volume might need to be scanned before the complete set of shared out files can be identified.

In step 305, the shared by me query on the file index returns a list of the user's shared out items, such as folders, files, or other items. Although the folders and files returned may reside in many different physical folders on the computer, the index query may still return a simple result set, such as a flat list or single table, rather than returning a complex structure representative of the file system hierarchy. This simple list view may be preferable to allow a user to quickly view all of that user's shared out items. Thus, in step 307, the user's shared out folders, files, and other items, are displayed to the user in a search folder. Search folders displayed in operating system views may closely resemble physical folders. However, search folders expose items in different views based on their metadata, instead of based on the actual physical underlying file system structure on the disk. That is, the items presented at the same level in a search folder need not reside in the same physical location on the computer, or at the same hierarchical level of a file system.

In certain embodiments, the above shared by me query may be configurable to return only the items directly shared out by the owner. In many operating systems, user permissions are frequently created and assigned by the operating system itself. Such system-assigned permissions may, for example, grant various classes of computer administrators access to user-owned files. When performing a search/query for shared out files, a user may prefer to have the “noise” of these system-assigned permissions filtered out, in order to quickly and easily view the list of user permissions that user has personally granted to other users. Thus, the search/query may include a filter to return only the files shared as the result of a user-initiated action, such as the user explicitly changing the ACL for a file or folder. Additionally, the shared by me query may be configured not to return every file on the computer owned and shared by the user, but may instead filter out certain classes of files, for example, hidden files or system files, that are not likely to be of interest to the user performing the search/query. As mentioned above, in further aspects, the shared by me query may be configured to return only files actually shared by the user, or files in a certain location in the file system hierarchy. Additionally, noise filters may remove any files shared to the system from the query results, or may be configured to filter out any shared files where only certain incomplete or irrelevant permissions have been shared. For example, a user may have been granted permissions to edit security permissions on a file, without having been granted any permissions to read or edit the file. Thus, through such filter, a file or folder might only be considered as shared if the sharee actually has permission to open the file or folder and access the content in that file or folder.

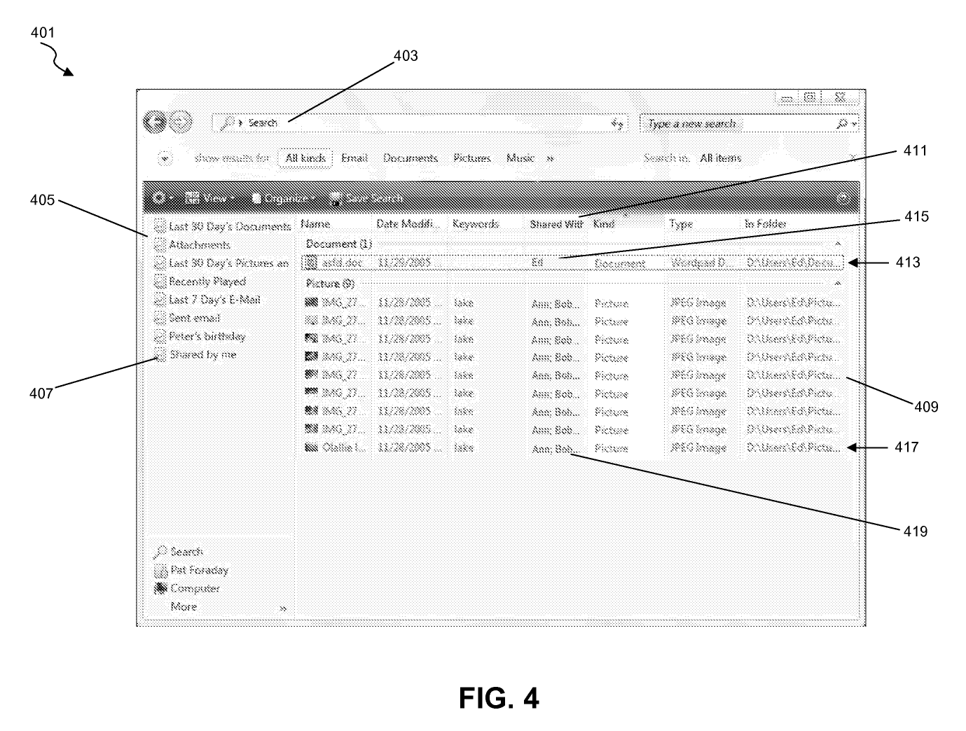

Referring to FIG. 4, a screenshot of a user interface 401 is shown demonstrating illustrative steps for displaying a list of shared files on a computer, for example, corresponding to the results of the shared by me query returned and displayed in step 307.

In the user interface, search view 401 may include an address tool bar 403 to indicate to the user the location of this user interface view 401 within the operating system task hierarchy. In this example, the address tool bar 403 reads “Search,” informing the user that the current view may appear immediately after the Search option is selected from the top-level menu of the operating system task hierarchy. For example, in a Microsoft Windows® brand operating system, a search option may be found in the first level of the start menu.

The large bottom portion of the search view 401 is divided into a search pane 405 and a results pane 409. The search view 401 uses panes 405 and 409 to allow users to build and customize file searches, examples of which are displayed in the search pane 405. The shared by me query 407 is displayed in the search pane 405, and may be executed by the user, for example, by clicking, double-clicking, or right-clicking the shared by me search 407, or by selecting the search 407 and then selecting another component on user interface 401 to execute/re-execute the selected search 407.

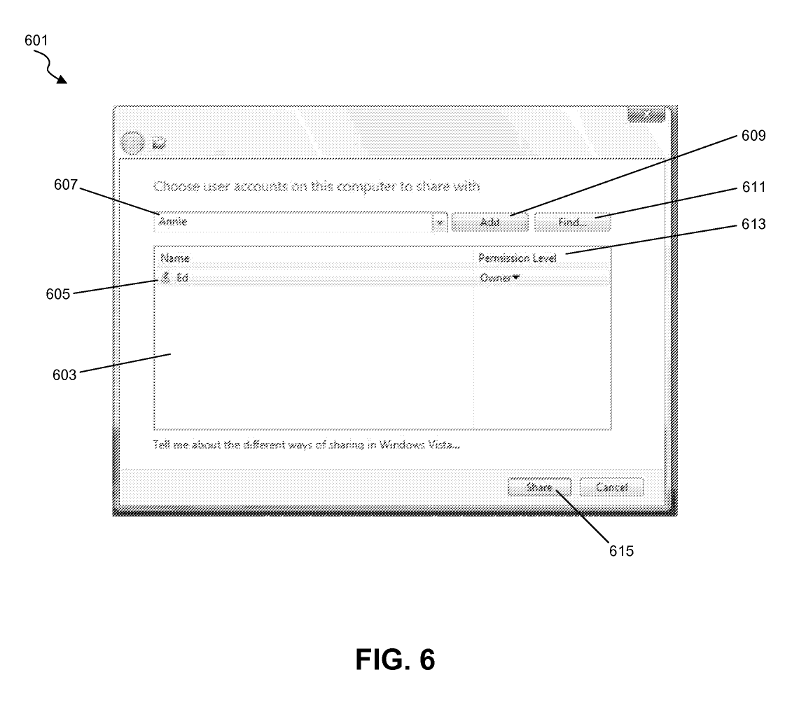

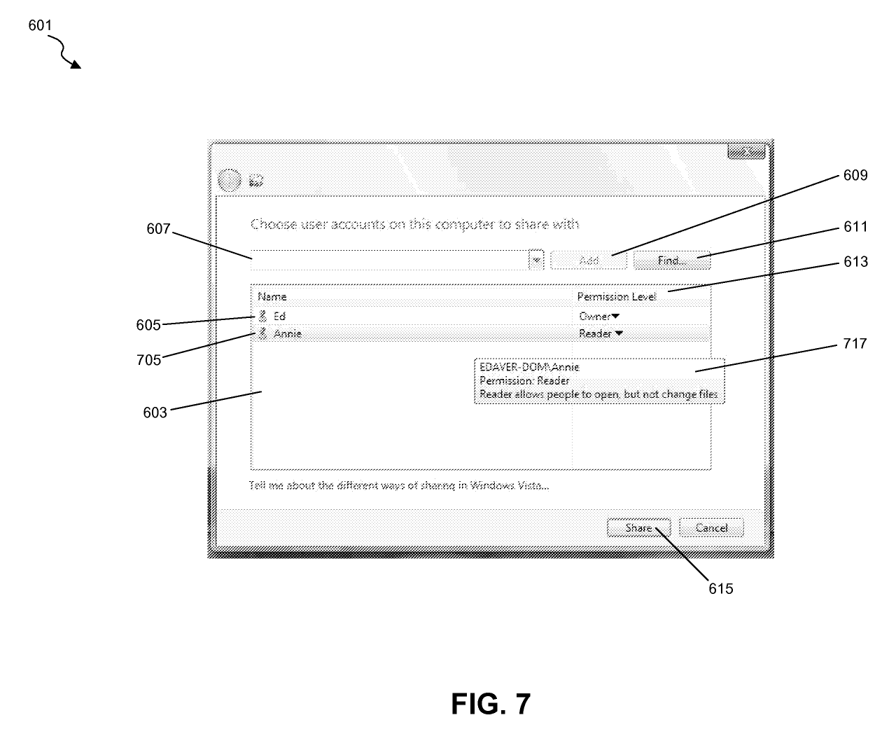

In view 401, the shared by me query 407 has been executed and the results pane 409 displays an illustrative result set of files shared by the current user. Several columns along the top of results pane 409 correspond to the properties and/or content of the files returned by the query 407. The set of properties displayed in the results pane 409 may be customizable by the user, and may include the physical location of the file, file name, file type, file size, creation date, last modified date, or other metadata information stored by the operating system. The shared with column 411 in the results pane 409 may display a list of users for each item in the results pane 409 corresponding to the users that have been granted some level of access to that item. The shared with column 411 may be a semicolon-delimited list of usernames, as shown in this example, or may alternatively take the form of an embedded table, dropdown, or one or more other user interface components describing the user permissions granted on the items. Thus, in view 401, the shared with field 415 of document item 413 may be displayed to inform the user that the document “asfd.doc” has been shared out to the user “Ed.” Similarly, the shared with field 419 of picture item 417 indicates that the picture has been shared with multiple users. The ellipsis in field 419 is a common user interface technique to inform to the user that the complete shared with list can not be rendered due to the limited visible space of the field 419. The user may observe this ellipsis and decide to view the entire list by, for example, adjusting the column size 411 at the top of the result pane 409, or hovering a mouse cursor over the field 419 to view a complete list of shared with usernames. Alternatively, a subsequent user action, for example, selecting or double-clicking the shared with field 419 may invoke a new user interface view containing a complete list of shared with users along with the permission level associated with each user. An illustrative view of such a user interface is shown in FIGS. 6-7 and described in detail below.

Although the illustrative user interface 401 does not display the level of permissions associated with any of the shared with users, certain other embodiments may display this information directly in the results pane 409 of a user interface search view 401. For example, an icon or color-coding scheme may denote the different level of permissions associated with each user (e.g., owner, read-only, etc.) in the shared with column 411. Further aspects may permit sorting or grouping of the results pane 409 of the user interface search view 401, for example, to group the results by who the item is shared to.

In addition to viewing user permissions for shared items, search view 401 may also be used to set user permissions, either within view 401 itself, or by invoking a different user interface view, such as the views shown in FIGS. 6-7 and described in detail below. In certain embodiments, a user may directly edit the fields in the shared with column 411 to change the user permissions defined for an item. For example, the file owner may select and delete field 415 of item 413 to remove all permissions on the file associated with the user Ed. Thus, a subsequent execution of the shared by me search 407, or simply a refreshing of the user interface view 401, may update the results pane 409 to remove asfd.doc 413 from view 401. In another example, search view 401 may support dragging and dropping user names into a field in the shared with column 411 to add user permissions to the item, similar to the way that files may be copied by dragging and dropping from one folder view to another. Other related scenarios may be supported to permit an item owner to unambiguously update the permissions of the items displayed in the results pane 409 without invoking another user interface view. However, it may be useful to provide certain functionality, such as editing permissions, in a separate user interface view, due to the many different choices available to a user when sharing items, such as selecting a complete list of users and/or groups of users, setting the level of permissions for each user and/or group.

In certain embodiments, the search view 401 and the associated query infrastructure described herein may be used to allow a user to simply and efficiently perform other system searches based on user permissions. For example, the user may search for all files not owned by the user but shared out to the user. Such a search may be saved as a default search, for example, a “Shared to me” search, and may be displayed in the search pane 405.

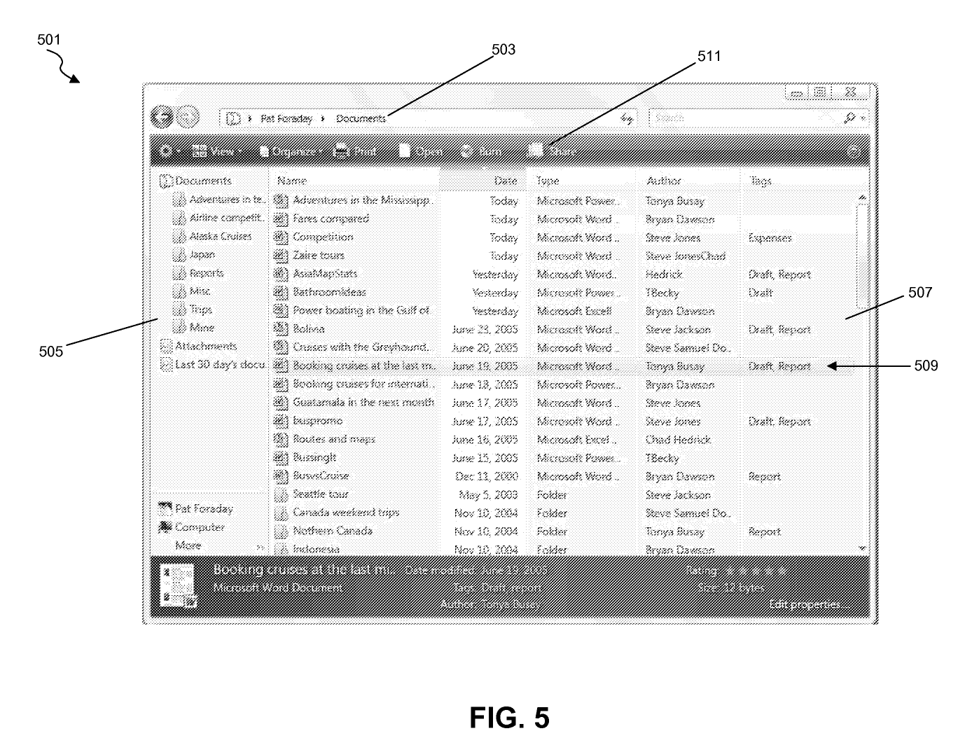

Referring to FIG. 5, a screenshot of a user interface view 501 is shown demonstrating illustrative steps relating to sharing one or more items on a computer. View 501 shows an illustrative list view of a subfolder named “Documents” in a top-level folder named “Pat Foraday,” as indicated by address tool bar 503. In contrast to the search view 401, the items displayed in view 501 are related by physical location in the file system hierarchy, rather then based on a file system search. However, view 501 may be similarly configured and may place a folder pane 505 on the left side of the display screen and a contents pane 507 on the right side. A typical operating system list view is shown in contents pane 507, including files, folders, and possibly other non-file items. The user may sort, scroll, and examine the contents pane to identify one or more items of interest to the user. As in known systems, the user may view properties or open a selected item through the view 501.

Additionally, a user may select one or more items in the contents pane 509 then use the share button 511 to view or update the user permissions for the selected items. In this example, the user may wish to share out the selected document 509 to certain other users on the system, and may click the share button 511 to invoke a new user interface view shown in FIGS. 6-7. If however, the current user does not have owner-level permissions, the user might not be able to share the file 509 and the share button 511 may be unresponsive or inactive when a non-owned filed is selected in the contents pane 509. A user may also have permissions to view some or all user permissions set on a non-owned item, such as their own privileges, but might not be authorized to set any user permissions on the item. In such cases, the share button 511 may present a user interface view that displays certain permissions associating with the item, for example, the user's privileges, but does not display certain other user permissions and does not permit user editing of the user permissions on the item.

Referring to FIG. 6, a screenshot of a user interface view 601 is shown demonstrating illustrative user steps for setting permissions on one or more items. The set permissions view 601 may be invoked by different user actions from different functional views in the operating system. For example, set permissions view 601 may appear after a user selects files and then clicks the share button 511 in FIG. 5, or may appear after a user double-clicked the shared with field 413 in FIG. 4.

Share list 603 includes the username and permission level for all users granted permissions on the selected file. In this example, the user Ed 605 has been granted owner-level permissions on the item. Besides simply viewing the current share list 603, view 601 allows an authorized user to update the user permissions on an item. The user may input a name, for example, a user name, group name, or security principle name that may be associated with an account on the computer, into a region 607, then click the add button 609 to add the user 607 to the share list 603. In various embodiments, the user may directly type a user name into a text box 607, or alternatively may select a user name from a dropdown 607 including a set of names corresponding to user accounts on the computer. Finally, a user may click a find button 611 for assistance in locating a user or group account on the computer. The find button 611 may invoke, for example, a user interface view displaying a set of user names on the computer and allowing the user to drag and drop user names from the set into the current share list 603.

In certain embodiments, an owner may remove a user from the share list 603 by selecting the user and performing a deletion action, for example, typing a delete key on a keyboard, clicking a remove button (not shown), or right-clicking the select user and choosing a delete option from a menu.

FIG. 7 is a continuation of the screenshot view 601 shown in FIG. 6, demonstrating illustrative user steps for setting permissions on items. The user Annie 705 has been added to share list 603, for example, by the user selecting Annie from the dropdown 607 containing the user names for all user accounts on the computer, and then clicking the add button 609. Using the permission level column 613 of the share user 705, the view user may change the user permissions for Annie 705, for example, to reader, writer (e.g., contributor), owner (e.g., co-owner), or another valid permission level associated with the item to be shared. Permission level column 613 may be a dropdown as shown in FIG. 6, a series of checkboxes where each checkbox is associated with a specific user action, or another set of user interface components designed to allow users to designate user permissions. A mouseover dialog 717 may further assist an owner by explaining a permission level in greater detail. After an owner sets the desired user permissions on the item, the owner may then click the share button 615 to update the user permissions within the operating system, effectively sharing the items with the chosen users.

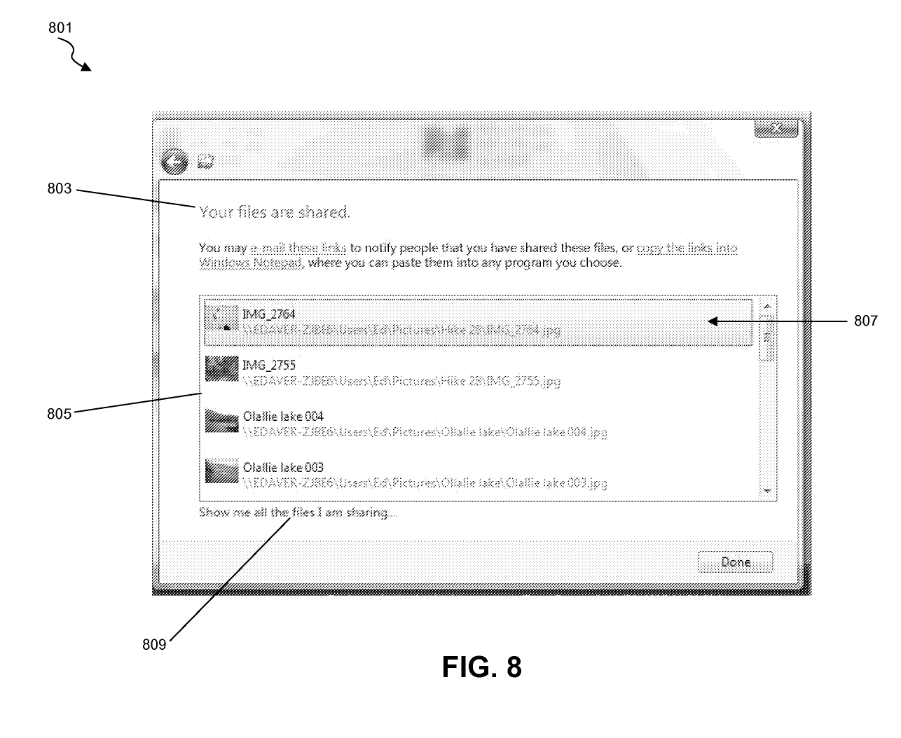

Referring to FIG. 8, a screenshot of a user interface view 801 is shown confirming the sharing of files on a computer. View 801 may appear to an owner after clicking the share button 615 to confirm the sharing of one or more items. A confirmation message 803 may appear near the top of the view 801, and a list 805 may be displayed containing a list item for each item just shared by the owner. To improve usability for remote file sharing, the owner may select a shared item 807 and forward the basic information about the shared item, for example, the name and network address of the item, to a sharee. Finally, a link 809 may be provided to allow the owner to execute and view results of a shared by me query, as is described in detail above in relation to FIG. 4. In certain embodiments, a user clicking on link 809 may immediately be presented the search view 401, and shared by me query 407 may be automatically initiated to display results in the results pane 409.

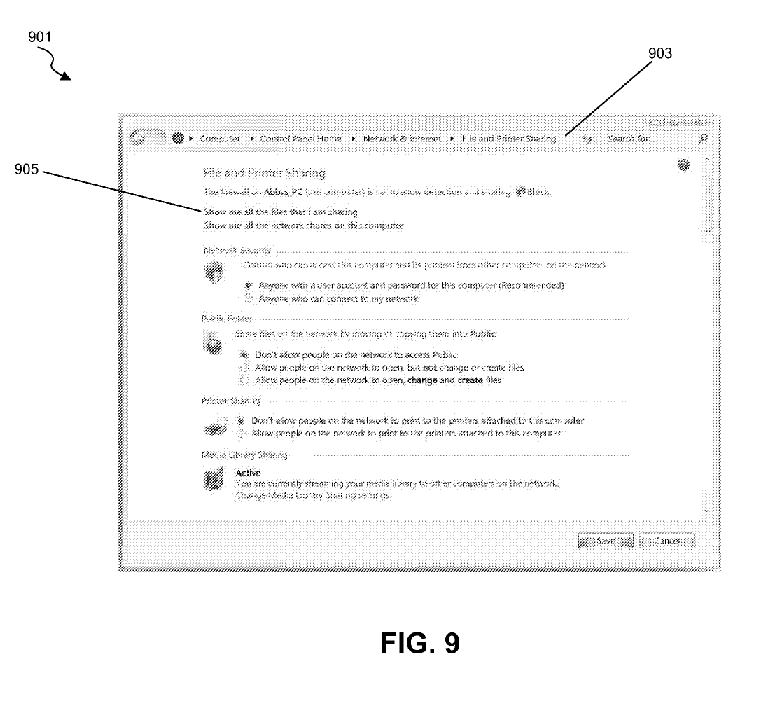

FIG. 9 is a screenshot of a user interface view 901 located in a central location in an operating system. As noted above, sharing items in an operating system may be related to many other operating system user tasks, such as managing printer sharing, public folders, SMB shares, and various computer and network security tasks. Different user interface views may be built for these tasks, and may be accessible to users in many different areas of the operating system task hierarchy. For example, view 901 allows a user to configure file and printer sharing and is accessible through the “Network & Internet” menu of the “Control Panel Home” menu, as indicated by the address tool bar 903. Since many of the tasks supported by view 901 relate to file sharing, a link 905 on the view 901 may present a user with an easy way to perform a shared by me query as described above in relation to FIG. 4. In certain embodiments, a user clicking on link 905 may immediately be presented the search view 401, and shared by me query 407 may be automatically initiated to display results in the results pane 409. Link 905 and other similar links may be placed in relation user interface views throughout the operating system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for displaying items in a computer operating system, the method comprising the steps of:
identifying a user of a computer;
identifying a plurality of items on the computer, each of said plurality of items owned by said user and associated with at least one other user; and
displaying said plurality of items.

2. The method of claim 1, wherein the step of identifying a user comprises identifying the current user of the computer.

3. The method of claim 1, wherein said plurality of items are displayed in a search folder, wherein a first item displayed in said search folder is stored in a first physical folder on the computer, and wherein a second item displayed in said search folder is stored in a second physical folder on the computer, different from said first physical folder on the computer.

4. The method of claim 1, wherein the step of identifying the plurality of items comprises executing a query on the computer, said query configured to return a set of items owned by said user and shared out by said user to at least one other user of the computer.

5. The method of claim 4, wherein executing said query comprises reading an index data structure stored on said computer, the index data structure storing references to a plurality of items on the computer, and including a user permission property.

6. The method of claim 5, wherein said index data structure stores an identifier associated with a file system permission for each item referenced in said index data structure.

7. The method of claim 5, wherein said index data structure contains a reference to at least one folder item and a reference to at least one non-folder file item.

8. One or more computer readable media comprising computer executable instructions which, when executed on a computer system, perform a method comprising:
determining a user on a computer;
identifying a first item located in a first physical folder on the computer, the first item owned by said user and associated with at least one other user on the computer;
identifying a second item located in a second physical folder on the computer, the second item owned by said user and associated with at least one other user on the computer, wherein said first physical folder is different from said second physical folder; and
displaying said first item and said second item in a search folder.

9. The computer readable media of claim 8, wherein said determined user is the current user of the computer.

10. The computer readable media of claim 8, wherein the steps of identifying the first and second item comprise executing a query, said query comprising reading an index stored on said computer, wherein said index stores information corresponding to a physical location of the first and second items on the computer, and user permissions associated with the first and second items.

11. The computer readable media of claim 10, wherein said index comprises a data structure that stores information associated with a plurality of files on the computer, and wherein said data structure is organized based on user permissions associated with said plurality of files.

12. The computer readable media of claim 11, wherein said index comprises a binary tree data structure.

13. The computer readable media of claim 8, wherein said first item comprises a file item and said second item comprises a folder item.

14. One or more computer readable media storing computer executable instructions for providing a user interface allowing a user to view file associations on a computer, said user interface comprising:
an item list displaying a plurality of items in a computer file system, each of said displayed items associated with a first user, said item list comprising:
one of a file name and a folder name displayed for each item in said item list;
a physical folder location displayed for each item in said item list, wherein said physical folder location displayed for a first item in said item list is different from a physical folder location displayed for a second item in said item list; and
a user permission property displayed for each item in said item list, each said user permission property comprising a reference to at least one user other than said first user on said computer.

15. The computer readable media of claim 14, wherein each of said displayed items is owned by said first user.

16. The computer readable media of claim 14, wherein said item list comprises at least one folder item and at least one non-folder file item.

17. The computer readable media of claim 14, wherein each said user permission property comprises a shared list of at least one user, said user interface further comprising:
an editable field displaying a permission level associated with each user in each said shared list of each displayed user permission property.

18. The computer readable media of claim 14, wherein said plurality of items are displayed in a search folder.

19. The computer readable media of claim 18, wherein said search folder displayed is sorted according to the physical location of said plurality of items.

20. The computer readable media of claim 18, wherein said search folder displayed is sorted according to the user permission property of said plurality of items.
